(19) United States
(12) Patent Application Publication
(10) Pub. No.: US 2024/0385916 A1
(43) Pub. Date: Nov. 21, 2024

(54) AUTO-BLOCKING SOFTWARE DEVELOPMENT KITS BASED ON USER CONSENT

(71) Applicant: OneTrust, LLC, Atlanta, GA (US)

(72) Inventors: Pratik Doshi, Atlanta, GA (US); Spencer Wyckoff, Atlanta, GA (US)

(73) Assignee: OneTrust, LLC, Atlanta, GA (US)

(21) Appl. No.: 18/687,219

(22) PCT Filed: Oct. 3, 2022
(86) PCT No.: PCT/US2022/045520

§ 371 Date: Feb. 27, 2024

Related U.S. Application Data
(60) Provisional application No. 63/251,272, filed on Oct. 1, 2021.

(51) Int. Cl. G06F 9/54

(52) U.S. Cl. CPC G06F 9/547

(57) ABSTRACT

Aspects of the present invention provide methods, apparatuses, systems, computing devices, computing entities, and/or the like for auto-blocking of software development kit functionality for mobile software applications based on consent (or lack thereof) provided by users who are interacting with the mobile software applications.

### CROSS-REFERENCE TO RELATED APPLICATIONS

This application claims the benefit of U.S. Provisional Patent Application Ser. No. 63/251,272, filed Oct. 1, 2021, which is hereby incorporated herein by reference in its entirety.

### TECHNICAL FIELD

The present disclosure is generally related to systems and methods for controlling the functionality provided through software development kits for the purpose of protection of information and services from unauthorized modification or disclosure.

### BACKGROUND

Although mobile software applications (mobile apps) are built using native functionality written by in-house developers, almost all of them source some functionality (e.g., non-native functionality) through third-party software development kits (SDKs). It is not uncommon for a mobile application to make use of twenty or more SDKs in implementing various functionality for the application. That is to say, leveraging components provided through third-party SDKs has become a common practice used today in mobile application development. A popular reason for using SDKs is that they can provide mobile applications with all sorts of functionality that would be incredibly time consuming for developers to build, as well as provide many organizations who develop mobile applications with other opportunities for monetizing their mobile applications.

For example, advertising SDKs are commonly used in mobile applications to help generate revenue by displaying advertisements to users. An advertising SDK provides functionality to allow a mobile application to connect to third-party services and/or technologies (e.g., ad networks) to run advertisements in the application. Similarly, social media SDKs are used by many developers to create mobile applications that are integrated into larger social media landscapes. A social media SDK can provide functionality such as streamlined user logins, application data and analytics, and/or various gaming features.

However, a great deal of functionality provided through third-party SDKs involve the use of personal data of the users of the mobile applications. For example, functionality may be provided through a third-party SDK in a mobile application that accesses global positioning system (GPS) data on a user's smartphone device to determine a location of the user. Oftentimes, users are required to provide their consent to have personal data used for such functionality. Thus, a developer of a mobile application is often tasked with not only keeping track of functionality provided through various third-party SDKs that make use of personal data so that consent can be solicited from users of the application, but also implementing functionality to solicit such consent and to block functionality that makes use of personal data when a user declines to provide consent for the functionality. Thus, a need exists in the art for systems and methods for managing and soliciting consent for various functionality provided through third-party SDKs found in mobile software applications and actioning such consent to block functionality when needed.

### SUMMARY

In general, various aspects provide methods, apparatuses, systems, computing devices, computing entities, and/or the like for soliciting consent for various functionality provided through third-party SDKs found in mobile software applications and take action to block functionality when consent has not been provided. In accordance with one aspect, a method is provided that comprises: generating, by computing hardware, a first application interface (API) call over a network to a remote computing system to request a list of software development kits (SDKs) providing functionality for a mobile application; receiving, by the computing hardware and from the remote computing system, the list of SDKs over the network, wherein the list of SDKs comprises a first SDK associated with a first functionality category and a second SDK associated with a second functionality category; causing, by the computing hardware, display of a consent interface within the mobile application, wherein the consent interface comprises: a first input element configured for receiving consent for the first functionality category, and a second input clement configured for receiving consent for the second functionality category; receiving, by the computing hardware and via the first input element, first input indicating the consent for the first functionality category; receiving, by the computing hardware and via the second input element, second input indicating a lack of the consent for the second functionality category; responsive to the first input, allowing, by the computing hardware, first functionality provided by the first SDK to operate within the mobile application; and responsive to the second input, generating, by the computing hardware, a second API call to block the second SDK from initiating second functionality operating for the mobile application.

In some aspects, the method further comprises logging the first input and the second input on at least one of the remote computing system or the computing hardware. In some aspects, after logging the first input and the second input, the method further comprises: detecting, by the computing hardware, a user interacting with the mobile application; and responsive to detecting the user interacting with the mobile application: retrieving, by the computing hardware, the first input and the second input; responsive to the first input, allowing, by the computing hardware, the first functionality provided by the first SDK to operate within the mobile application; and responsive to the second input, generating, by the computing hardware, a third API call to block the second SDK from initializing the second functionality operating for the mobile application.

In some aspects, the list of SDKs comprises a third SDK associated with a third functionality category, and the method further comprises: determining, by the computing hardware, that consent for the third functionality category is not required; and responsive to determining the consent for the third functionality category is not required, causing, by the computing hardware, display of the consent interface within the mobile application without a third input element configured for receiving the consent for the third functionality category. In some aspects, determining that the consent for the third functionality category is not required comprises: determining a location of at least one of the computing hardware or a user of the mobile application; and determining that the consent for the third functionality category is not required based on the location.

In some aspects, the second API call to block the second SDK from initiating the second functionality performs at least one of setting a consent flag that indicates to the second SDK not to initialize or directing preventing the second SDK from initializing. In some aspects, the list of SDKs comprises a third SDK, and the method further comprises: causing, by the computing hardware, display of the consent interface within the mobile application, wherein the consent interface comprises a third input element configured for receiving consent for the third SDK; receiving, by the computing hardware and via the third input element, third input indicating a lack of the consent for the third SDK; and responsive to the third input, generating, by the computing hardware, a third API call to block the third SDK from initiating third functionality operating for the mobile application.

In accordance with other aspects, a system is provided that comprises a non-transitory computer-readable medium storing instructions and a processing device communicatively coupled to the non-transitory computer-readable medium. The processing device is configured to execute the instructions and thereby perform operations comprising: decompiling a software application to produce application code for the software application; scanning the application code to identify at least one of non-native functionality, a non-native attribute, or a non-native characteristic of the application code; accessing a repository containing data on known third-party software development kits (SDKs); identifying, based on the data in the repository, at least one of known functionality, a known attribute, or a known characteristic that matches at least one of the non-native functionality, the non-native attribute, or the non-native characteristic; determining, based on at least one of the known functionality, the known attribute, or the known characteristic, a source SDK for at least one of the non-native functionality, the non-native attribute, or the non-native characteristic; assigning a functionality category to at least one of the non-native functionality, the non-native attribute, or the non-native characteristic; and storing, in a second repository, an indication of the source SDK and the functionality category for the software application.

In some aspects, the software application comprises a mobile application for a mobile device. In some aspects, scanning the application code identifies at least one of second non-native functionality, a second non-native attribute, or a second non-native characteristic of the application code, and the operations further comprise: executing the software application; providing the software application, while executing, dummy data to generate output that is associated with at least one of the second non-native functionality, the second non-native attribute, or the second non-native characteristic; analyzing the output; identifying, based on analyzing the output, a second source SDK for at least one of the second non-native functionality, the second non-native attribute, or the second non-native characteristic; assigning a second functionality category to at least one of the second non-native functionality, the second non-native attribute, or the second non-native characteristic; and storing, in the second repository, a second indication of the second source SDK and the second functionality category for the software application. In some aspects, identifying the second source SDK for at least one of the second non-native functionality, the second non-native attribute, or the second non-native characteristic via executing the software application is carried out based on a failure to identify at least one of second known functionality, a second known attribute, or a second known characteristic that matches at least one of the second non-native functionality, the second non-native attribute, or the second non-native characteristic from the data in the repository.

In some aspects, analyzing the output comprises processing the output using a machine-learning model to generate a prediction for each third-party SDK of a plurality of third-party SDKs, wherein the prediction provides a likelihood of the third-party SDK being a source of at least one of the second non-native functionality, the second non-native attribute, or the second non-native characteristic. In some aspects, the second source SDK is one of the plurality of third-party SDKs and identifying the second source SDK for at least one of the second non-native functionality, the second non-native attribute, or the second non-native characteristic is based on the prediction generated for the second source SDK at least one of having a highest value of the predictions or satisfying a threshold.

In some aspects, the operations further comprise generating, based on the indication of the source SDK and the functionality category for the software application, a consent SDK that is incorporated into the software application and is configured to: cause display of a consent interface within the software application, wherein the consent interface comprises an input element configured for receiving consent for the functionality category, receive, via the input element, an input indicating a lack of the consent for the functionality category, and responsive to the input, generating an application programming interface call to block the source SDK from initiating functionality operating for the software application.

In addition, in accordance with other aspects, a non-transitory computer-readable medium having instructions that are stored thereon is provided. The instructions, when executed by computing hardware, configure the computing hardware to perform operations comprising: generating a first application interface (API) call over a network to a remote computing system to request a list of software development kits (SDKs) providing functionality for a software application; receiving, from the remote computing system, the list of SDKs over the network, wherein the list of SDKs comprises a first SDK associated with a first functionality category; causing display of a consent interface within the software application, wherein the consent interface comprises an input element configured for receiving consent for the first functionality category; receiving, via the input element, input indicating a lack of the consent for the first functionality category; and responsive to the input, generating a second API call to block the first SDK from initiating first functionality operating for the software application.

In some aspects, the operations further comprise logging the input on the remote computing system. In some aspects, after logging the input, the operations further comprises: detecting a user interacting with the software application; responsive to detecting the user interacting with the software application: retrieving the input; and responsive to the input, generating a third API call to block the first SDK from initializing the first functionality operating for the software application.

In some aspects, the list of SDKs comprises a second SDK associated with a second functionality category, and the operations further comprise: determining that consent for the second functionality category is not required; and responsive to determining the consent for the second functionality category is not required, causing display of the consent interface within the software application without a second input element configured for receiving the consent for the second functionality category. In some aspects, the second API call to block the first SDK from initiating the first functionality performs at least one of setting a consent flag that indicates to the first SDK not to initialize or directing preventing the first SDK from initializing. In some aspects, the list of SDKs comprises a second SDK, and the operations further comprise: causing display of the consent interface within the software application, wherein the consent interface comprises a second input element configured for receiving consent for the second SDK; receiving, via the second input element, second input indicating a lack of the consent for the second SDK; and responsive to the second input, generating a third API call to block the second SDK from initiating second functionality operating for the software application.

### BRIEF DESCRIPTION OF THE DRAWINGS

In the course of this description, reference will be made to the accompanying drawings, which are not necessarily drawn to scale, and wherein:

FIG. 1 depicts an example of a computing environment that can be used for implementing auto-blocking of third-party SDKs based on user consent in accordance with various aspects of the present disclosure;

FIG. 2 depicts an overview of a computational process that can be used for implementing auto-blocking of third-party SDKs based on user consent in accordance with various aspects of the present disclosure;

FIG. 3 is an example of a process performed for analyzing a mobile application to identify third-party SDKs used for the application in accordance with various aspects of the present disclosure;

FIG. 4 is an example of a process performed for soliciting consent for different functionality categories and actioning the consent in accordance with various aspects of the present disclosure;

FIG. 5 depicts an example of a user interface facilitating the setting of consents for a group of SDKs that can be used in accordance with various aspects of the present disclosure;

FIG. 6 is a block diagram illustrating an example system architecture that may be used in accordance with various aspects of the present disclosure; and

FIG. 7 is a schematic diagram of an example computing entity that may be used in accordance with various aspects of the present disclosure.

### DETAILED DESCRIPTION

Various aspects for practicing the technologies disclosed herein are described more fully hereinafter with reference to the accompanying drawings, in which some, but not all, aspects of the technologies disclosed are shown. Indeed, the aspects disclosed herein are provided so that this disclosure will satisfy applicable legal requirements and should not be construed as limiting or precluding other aspects applying the teachings and concepts disclosed herein. Like numbers in the drawings refer to like elements throughout.

### Overview

As previously noted, a great deal of functionality found in mobile software applications (mobile apps) is implemented through the use of third-party SDKs that are provided by different vendors. It is not uncommon for a mobile application to make use of twenty or more SDKs in implementing various functionality in the mobile application. Oftentimes, functionality implemented through a third-party SDK may involve the use of personal data of a user. For example, a third-party SDK may provide functionality that monitors performance and records how a user moves through a mobile application. The collecting and recording of such movements can be considered collecting and recording the user's personal data. In another example, a third-party SDK may provide functionality that allows for a user to share content through the mobile application with friends and/or social media networks. Accordingly, the functionality may involve accessing the content, which can be considered the user's personal data. Therefore, the user is often required to provide his or her consent before such functionality can be allowed to operate for the mobile application. As a result, a developer of a mobile application is often tasked with not only keeping track of functionality provided through various third-party SDKs that make use of personal data so that consent can be solicited from users of the application, but also implement functionality to solicit such consent and to block functionality that makes use of personal data when a user has not provided consent for the functionality. However, this can lead to significant overhead, increased development time, efficiency, and increased cost in developing mobile software applications.

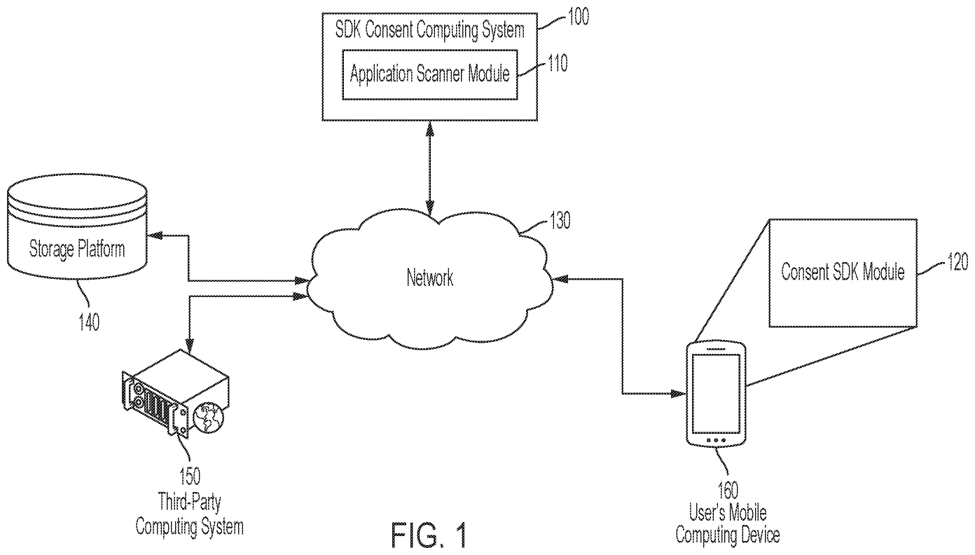

Accordingly, various aspects of the disclosure overcome many of the technical challenges of managing and actioning consent for functionality implemented for mobile software applications through the use of multiple third-party SDKs. FIG. 1 depicts an example of a computing environment for implementing auto-blocking of third-party SDKs based on user consent according to various aspects. For example, an entity (e.g., organization) may develop a mobile software application using a number of third-party SDKs that introduce functionality requiring user consent for allowing the functionality to operate.

The entity may make the software mobile application available (e.g., publish) to users through their own and/or a third-party storage platform 140, such as Apple's App Store. Once the application is ready for publishing, the entity may make the mobile software application available by distributing the software mobile application over a network 130 from a third-party computing system 150 associated with the entity to the third-party storage platform 140. The software mobile application includes one or more sets of program code that is executable by computing hardware (e.g., a user's mobile computing device 160) for performing one or more functions for controlling the mobile software application, providing content through the mobile software application, providing functionality within the mobile software application, and/or the like. A user may access the storage platform 140 for downloading the mobile software application to the user's mobile computing device 160. Here, the user's mobile computing device 160 may include a separate mobile software application for accessing the storage platform 140 and/or the user's mobile computing device 160 may include a browser application which the user uses to navigate to an address (e.g., uniform resource locator) for the storage platform 140 over a network 130 (e.g., Internet or cellular).

The entity providing the mobile software application may be interested in implementing functionality to request consent for functionality associated with one or more third-party SDKs used within the application and actioning the consent (or lack thereof) accordingly. In various aspects, an SDK consent computing system 100 can provide a service for analyzing (e.g., scanning) the mobile software application to identify the third-party SDKs that have been used in implementing functionality into the application, and implementing further functionality to request consent from users of the application and actioning the consent accordingly. The SDK consent computing system 100 can receive the mobile software from the entity associated with the application by the entity making the application (e.g., the one or more sets of program code for the application) available to the SDK consent computing system 100. For example, the SDK consent computing system 100 can receive the mobile software application via the entity uploading the mobile software application over a network 130 (e.g., the Internet) to the SDK consent computing system 100 from the third-party computing system 150. In another example, the SDK consent computing system 100 can retrieve the mobile software application from the third-party computing system 150. Yet, in another example, the SDK consent computing system 100 can perform the analysis on the mobile software application directly in the third-party computing system 150.

In various aspects, the SDK consent computing system 100 comprises computing hardware that executes an application scanner module 110 in conducting the analysis on the mobile software application. The application scanner module 110 scans the mobile software application to identify the use of third-party SDKs in implementing certain functionality within the application. In some aspects, the application scanner module 110 places the identified SDKs into various categories so that consent may be solicited from users of the mobile software application for the various categories.

In addition, a consent SDK module 120 is implemented within the mobile software application for soliciting consent from users for the functionality associated with the various third-party SDKs and actioning the consent accordingly. In some aspects, the consent SDK module 120 is implemented into the mobile software application by an individual associated with the application (e.g., developer) during the development of the mobile software application. For example, the consent SDK module 120 can be implemented into the mobile software application by the individual while the individual is developing the application on the third-party computing system 150.

Once implemented, the mobile software application can be downloaded by a user to his or her mobile computing device 160 with the consent SDK module 120 implemented within the mobile software application. In turn, the consent SDK module 120 can then solicit consent from the user for allowing the functionality associated with the different third-party SDKs (e.g., categories of third-party SDKs) to operate. The consent SDK module 120 can also action the consent received from the user to either allow the functionality to operate or block the functionality from operating at all.

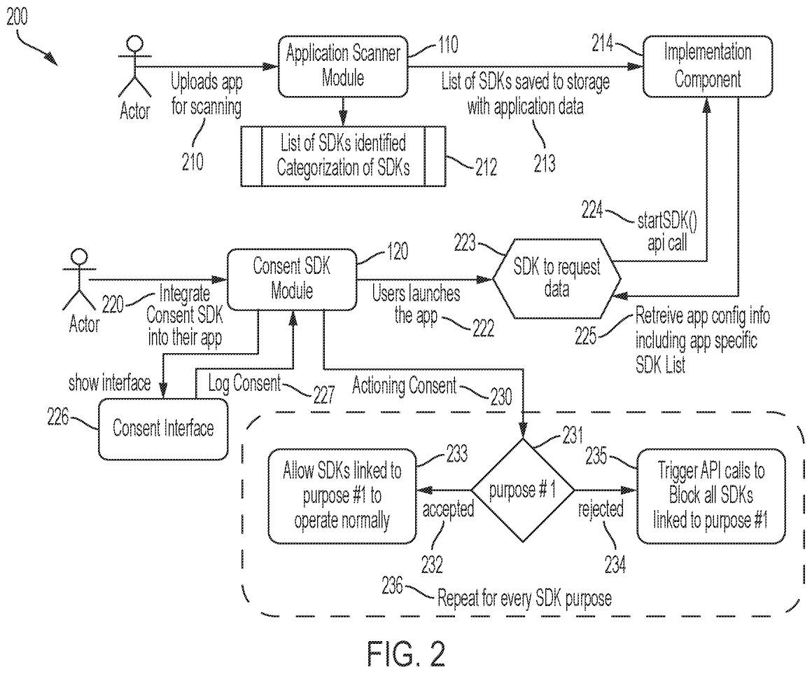

Turning now to FIG. 2, an overview 200 of a process that can be used for implementing auto-blocking of third-party SDKs for a mobile application based on user consent is shown according to various aspects. Initially, the SDK consent computing system 100 performs an analysis of the mobile software application (or just mobile application) to identify the third-party SDKs used in developing the mobile application and categorizing the third-party SDKs based on the functionality provided by the SDKs. In some aspects, the SDK consent computing system 100 categorizes a third-party SDK based on the functionality provided by the SDK that requires consent from a user (e.g., functionality provided by the SDK that involves the use of personal data).

For example, a first functionality category may be enhanced related functionality. Here, the third-party SDKs that are associated with this category provide functionality that involves monitoring a user's activities within the mobile application to provision enhanced and/or personalized functionality through the mobile application. The enhanced and/or personalized functionality may be set by third-party providers whose services have been added to the mobile application through the third-party SDKs. Accordingly, the user's activities conducted in the mobile application can be considered personal data that requires the user's consent to monitor and record.

Another functionality category may be targeting/advertising related functionality. Various third-party SDKs provide functionality that involves running (e.g., displaying) advertisements in the mobile application. Here, a third-party SDK may implement functionality to record information on a user's activities in the mobile application so that a profile can be developed on the user. For example, the amount of time the user spends engaging with advertisements involving certain products shown to the user may be used in developing a profile so that more targeted advertisements may be provided to the user. Oftentimes, the information used for developing such a profile may be monitored and recorded by a third party other than the entity providing the mobile application. Accordingly, the user's information recorded to develop the profile can be considered personal data that requires the user's consent to monitor and record.

Another functionality category may be social media related functionality. A number of third-party SDKs are available that provide functionality to integrate social features of various social media platforms, such as Facebook®, LinkedIn®, Twitter®, and/or the like, into a mobile application to enhance application data, analytics, and personalized experiences for application users. For example, a third-party SDK may provide functionality that accesses content such as photos on the user's mobile device that can then be shared through the mobile application on a social media platform. The user's content can be considered personal data that requires the user's consent to access.

Other functionality categories may include strictly necessary related functionality and performance related functionality. Strictly necessary related functionality involves third-party SDKs that can be essential for the provision of the mobile application and any requested services, but do not perform any additional or secondary function. Performance related functionality involves third-party SDKs that provide statistical information on application usage, such as application analytics. Third-party SDKs that fall into these two categories may provide functionality that often does not involve the use of personal data. Therefore, the user's consent may not be necessary and/or requested for the functionality provide by these types of third-party SDKs in many instances.

The SDK consent computing system 100 can receive the mobile application for analysis by an individual involved with the mobile application (e.g., a developer of the mobile application) uploading the mobile application 210 into the SDK consent computing system 100 for analysis. In various aspects, the SDK consent computing system 100 includes an application scanner module 110 that conducts a static and/or dynamic analysis on the mobile application to identify the third-party SDKs that were used in developing the mobile application. The application scanner module 110 conducts the static analysis by deconstructing (e.g., decompiling) the code for the mobile application and identifying functionality, attributes, characteristics, and/or the like found in the code that are associated with third-party SDKs. In other words, the application scanner module 110 can identify the functionality, attributes, characteristics, and/or the like that were not generated by a developer and are non-native to the mobile application. In some aspects, the application scanner module 110 compares the non-native functionality, attributes, characteristics, and/or the like with functionality, attributes, characteristics, and/or the like found in an SDK repository (library) that contains information on known third-party SDKs used in developing mobile applications. The application scanner module 110 can perform the comparison to identify known third-party SDK(s) found in the SDK repository that have been used to implement the non-native functionality, attributes, characteristics, and/or the like identified in the code of the mobile application. Once the third-party SDKs have been identified, the application scanner module 110 identifies a functionality category for each third-party SDK. In additional or alternative aspects, the application scanner module 110 can find the category in the SDK repository along with the information on the matching SDK. In additional or alternative aspects, the application scanner module 110 can identify a category for an SDK based on the information found in the repository on the matching SDK. For example, the application scanner module 110 can identify the social media functionality category for a third-party SDK based on information found in the SDK repository indicating the third-party SDK provides functionality allowing for streamlined user login for a social media platform within a mobile application.

In additional or alternative aspects, the application scanner module 110 can perform a dynamic analysis on the mobile application in addition to, or instead of, the static analysis. For instance, if the application scanner module 110 cannot identify a known SDK in the SDK repository for particular non-native functionality, attributes, characteristics, and/or the like found in the code, then the application scanner module 110 can perform a dynamic analysis that involves executing the mobile application, providing input to the mobile application, and monitoring the output produced from the mobile application. The output may be in the form of communication traffic between the mobile application and one or more remote services that may be associated with functionality provided by one or more third-party SDKs. In some aspects, the application scanner module 110 can perform the dynamic analysis by processing the output from the mobile application using artificial intelligence to identify a functionality category for a third-party SDK associated with the output. For example, the application scanner module 110 may use artificial intelligence that involves using a machine-learning model that performs natural language processing on the output and identifies (predicts) a likely vendor of the third-party SDK associated with the output. In additional or alternative aspects, the application scanner module 110 can also use the artificial intelligence in assigning a functionality category for the third-party SDK based on the identified vendor.

The application scanner module's 110 analysis of the mobile application results in a list of third-party SDKs 212 identified for the mobile application, along with their corresponding categories, which the application scanner module 110 can save to storage (e.g., an application repository) 213, along with application data identifying the mobile application. The list of third-party SDKs 212 can then be used to action consent within the mobile application provided by users as they download the mobile application onto their devices and execute (interact with) the application.

In various aspects, a consent SDK module 120 is used to facilitate the actioning of the consent in a mobile application. In some aspects, the consent SDK module 120 can action the consent by blocking certain third-party SDKs from initiating during execution of the mobile application based on consent provided by users for the different functionality categories associated with the third-party SDKs. For example, if the consent SDK module 120 receives an indication that a particular user of the mobile application has declined to provide consent for a particular functionality category, then the consent SDK module 120 can block the third-party SDKs associated with the category so that their corresponding functionality is not performed.

In various aspects, the consent SDK module 120 can be implemented into the mobile application via an individual involved with the mobile application (e.g., the developer of the mobile application), working within a third-party computing system 150, integrating a consent SDK into the development of the mobile application 220. Once implemented, the consent SDK module 120 can then solicit a user for consent with respect to the different functionality categories and action the consent accordingly to block the functionality for certain third-party SDKs associated with the categories for which the user declines to provide consent.

When a user downloads the mobile application to his or her mobile computing device 160 and launches the application on the device 222, the consent SDK module 120 can request data 223 from an implementation component 214 (e.g., computing hardware found within the SDK consent computing system 100) by, for example, generating an application programming interface (API) call 224 over a network to the implementation component 214. The API call 224 can identify the particular mobile application. The implementation component 214 retrieves a configuration for the mobile application along with the list of third-party SDKs identified for the mobile application during the analysis and sends the application configuration and list of third-party SDKs to the mobile application 225.

In various aspects, the consent SDK module 120 displays a consent interface 226 to the user to solicit the user for consent for the different functionality categories associated with the third-party SDKs found in the list returned from the implementation component 214. For example, the consent interface 226 can provide a list of the categories along with some type of input element, such as a button, toggle, checkbox, and/or the like, for each category that the user can then use to indicate if he or she is providing or declining consent for the respective category. As a result, the consent SDK module 120 can then receive an indication that consent has been provided or not provided for each of the different categories and can log them 227.

At this point, the consent SDK module 120 actions 230 the various consents received from the user. In various aspects, the consent SDK module 120 actions the various consents by either allowing the third-party SDKs' associated functionality to execute or blocking the third-party SDKs from initializing so that the associated functionality is not executed for the mobile application. Therefore, the consent SDK module 120 determines whether the user has provided consent for a first purpose/category 231. If the user has provided consent 232 for the first purpose/category, then the consent SDK module 120 allows the third-party SDKs linked to the first purpose/category to operate and perform the functionality associated with the SDKs 233. That is to say, the consent SDK module 120 allows the third-party SDKs to operate and perform the functionality associated with the SDKs (e.g., such that the mobile application is able to perform the functionality provided by the third-party SDK). However, if the user has not provided consent 234 for the first purpose/category, then the consent SDK module 120 triggers API calls to block each of the third-party SDKs linked to the first purpose/category from initializing 235. As a result, the consent SDK module 120 prevents the functionality for the blocked SDKs from executing for the mobile application. The consent SDK module 120 repeats the actioning process for each functionality category 236.

According to various aspects, the process shown in FIG. 2 facilitates managing and actioning consent for functionality found in mobile software applications provided through multiple third-party SDKs. For example, consent from a user may be required for functionality provided through a third-party SDK that involves using personal data of the user. In various aspects, the process provides developers of mobile software applications with a consolidated technical solution to perform an analysis of mobile applications to identify the third-party SDKs that provide functionality requiring consent from users, and then recording, managing, and providing the results of the analysis during execution of the mobile application by users to solicit consent from the users and action the consent accordingly. As a result, various aspects of the disclosure can lead to reduced overhead, reduced development time, increased efficiency, and reduced cost in developing mobile software applications.

It is noted that reference is made throughout the remainder of the disclosure with respect to managing, obtaining, and actioning consent for functionality found in mobile software applications provided through multiple third-party SDKs. However, various aspects of the disclosure can be used in managing, obtaining, and actioning consent for other types of software applications beside mobile applications. For example, aspects of the disclosure can be applicable to gaming applications that are developed to run on gaming systems (consoles). Therefore, various aspects of the disclosure are not limited to use for mobile software applications and can be used for other types of software applications.

### Application Scanner Module

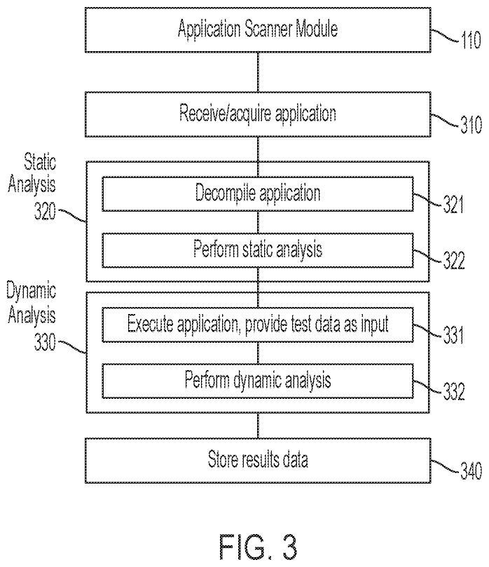

Turning now to FIG. 3, additional details are provided regarding an application scanner module 110 for analyzing a mobile application to identify third-party SDKs used for the application in accordance with various aspects of the disclosure. Accordingly, the process shown in FIG. 3 may correspond to operations carried out, for example, by a computing hardware described further herein, as it executes the application scanner module 110.

The process involves the application scanner module 110 receiving and/or acquiring a mobile application for analysis in Operation 310. In some aspects, the application scanner module 110 can receive the mobile application via an individual, such as a developer, uploading the mobile application for analysis into the SDK consent computing system 100. In additional or alternative aspects, the application scanner module 110 can receive the mobile application via the SDK consent computing system 100 obtaining identifying information about the mobile application from a user computing device or a consumer computing device that the SDK consent computing system 100 then uses to acquire the application from a third-party system that hosts, generates, or otherwise provides the application.

In Operation 320, the application scanner module 110 performing a static analysis on the mobile application. In various aspects, the application scanner module 110 performs the static analysis by first decompiling the application in Sub-Operation 321. For example, the application scanner module 110 can reduce the mobile application to source code, assembly language, machine code, and/or some other interpretation of the functions of the application, or an approximation thereof.

Once decompiled, the application scanner module 110 performs the static analysis of the application using the decompiled application code or the approximation of the decompiled application code in Sub-Operation 322. In various aspects, the application scanner module 110 performs the static analysis by scanning the application code to identify functionality, attributes, characteristics, and/or the like found in code that are not native to the application. The application scanner module 110 continues by using the non-native functionality, attributes, characteristics, and/or the like in identifying third-party SDKs used in implementing the non-native functionality, attributes, characteristics, and/or the like.

In some aspects, the application scanner module 110 accesses a third-party SDK repository (e.g., database) that contains information about known third-party SDKs that may have been used in developing the application under analysis. The application scanner module 110 matches the non-native functionality, attributes, characteristics, and/or the like identified in the code with known functionality, attributes, characteristics, and/or the like for the known third-party SDKs found in the SDK repository to determine one or more source SDKs for the non-native functionality, attributes, characteristics, and/or the like identified in the code. Once the third-party SDKs have been identified, the application scanner module 110 assigns a functionality category to each of the identified third-party SDKs. For example, the application scanner module 110 can identify a functionality category for each of the identified third-party SDKs from information found in the third-party SDK repository that identifies a functionality category for each of the known third-party SDKs found in the repository.

In additional or alternative aspects, the application scanner module 110 performs a dynamic analysis of the application in Operation 330. For example, the application scanner module 110 can perform the dynamic analysis for any non-native functionality, attributes, characteristics, and/or the like identified in the code that could not be matched to a third-party SDK during the static analysis. In performing the dynamic analysis, the application scanner module 110 executes the application and inspects the communications data and metadata (e.g., network traffic) transmitted and received by the application associated with the non-native functionality, attributes, characteristics, and/or the like. For example, the application scanner module 110 can inspect communications data and metadata originating from the application and/or directed to the application. In some aspects, the application scanner module 110 feeds data (e.g., “dummy input” data) as input to the application as it executes in Sub-Operation 331, and analyzes the output of the application (e.g., output associated with the non-native functionality, attributes, characteristics, and/or the like) using various technologies such as network and device diagnostic tools, packet sniffers, traffic analysis tools, and/or the like.

The application scanner module 110 then performs the dynamic analysis on the output of the application in Sub-Operation 332 to identify a functionality category for the non-native functionality, attributes, characteristics, and/or the like. In some aspects, the application scanner module 110 performs the dynamic analysis by processing the output of the application using artificial intelligence to identify the functionality category for the non-native functionality, attributes, characteristics, and/or the like. In particular aspects, the artificial intelligence comprises a machine-learning model configured to perform some type of natural language processing on the output to generate one or more predictions as to a likelihood of third-party (source) SDKs (and/or vendors thereof) being the source of the non-native functionality, attributes, characteristics, and/or the like. For example, the machine-learning model can perform text classification on the output. The machine-learning model can be a supervised or unsupervised trained model such as, for example, a Naïve Bayes model, liner support vector machine model, logistic regression model, neural network model, and/or the like.

The artificial intelligence may then select a particular third-party SDK and/or vendor as the source of the non-native functionality, attributes, characteristics, and/or the like based on the predictions generated for the different third-party SDKs and/or vendors. For example, the artificial intelligence may select the particular third party SDK and/or vendor based on the prediction generated for the particular third party SDK and/or vendor having a highest value with respect to the other predictions and/or the prediction satisfying a threshold. The artificial intelligence can then use the particular third-party (source) SDK and/or vendor in assigning a functionality category to the non-native functionality, attributes, characteristics, and/or the like.

Once the analysis has been performed, the application scanner module 110 can store the results in an application repository in Operation 340. The application scanner module 110 can store all, or any subset of, the results of the analysis performed by either or both of the static analysis and the dynamic analysis, any related data, and any representations and indications of such results and data in the application repository. In various aspects, the consent SDK module 120 can use the results of the analysis of the application in soliciting consent from different users of the application for the various functionality categories associated with the different third-party SDKs identified for the application, and actioning the consent accordingly to allow for functionality associated with the different third-party SDKs to execute or not.

### Consent SDK Module

In various aspects, the SDK consent computing system 100 can use the results of the analysis in designing a custom SDK that is incorporated into the mobile application to facilitate soliciting consent for various functionality categories from users of the mobile application and actioning the consent accordingly with respect to the third-party SDKs associated with the different functionality categories. For example, the SDK consent computing system 100 can build and/or customize a consent interface based on input provided by an individual (e.g., a developer) that can be displayed in the mobile application for soliciting the consent for the different functionality categories. In some aspects, the SDK consent computing system 100 can personalize the consent interface displayed to users in the mobile application to include specific wording for each of the functionality categories and/or to add branding to the consent interface. In additional or alternative aspects, the SDK consent computing system 100 can generate a mobile script to include in the consent SDK based on the individual's customization of the consent interface, as well as action consent received from a user accordingly.

Once the SDK consent computing system 100 has finished with generating the mobile script to include in the consent SDK, the SDK consent computing system 100 can publish the consent SDK so that the consent SDK can be implemented into the corresponding mobile application. For example, once the consent SDK has been published, a developer, working within a third-party computing system 150, can import the consent SDK into the application project for the mobile application to implement the consent functionality into the mobile application. As a result, during initialization of the mobile application (e.g., launching of the mobile application by a user) or at some other time, a consent SDK module 120 can solicit consent from the user for the different functionality categories identified for the various third-party SDKs used for the mobile application and action the consent accordingly.

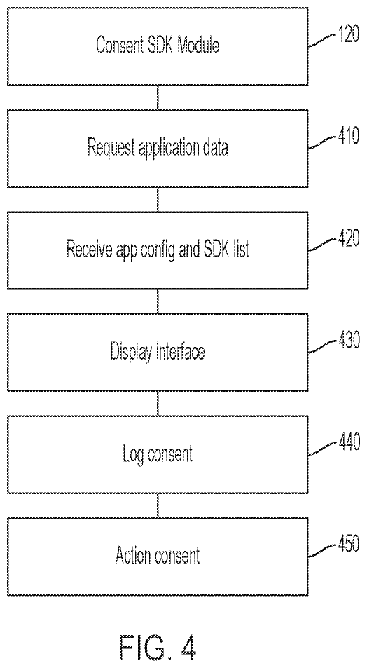

Turning now to FIG. 4, additional details are provided regarding a consent SDK module 120 for soliciting consent for different functionality categories and actioning the consent in accordance with various aspects of the disclosure. Accordingly, the process shown in FIG. 4 may correspond to operations carried out, for example, by a computing hardware described further herein, as it executes the consent SDK module 120 embedded in a mobile application. For example, a user may have downloaded the mobile application to his or her computing device and launched the mobile application on the device. In turn, the mobile application may recognize that it is being launched for the first time on the user's computing device and invoke the consent SDK module 120 accordingly.

The process involves the consent SDK module 120 requesting data on the application from an implementation component 214 in Operation 410. In various aspects, the consent SDK module 120 sends a request to the implementation component 214 to query the data on the application from the application repository storing configuration information on the particular mobile application that includes a list of third-party SDKs identified for the mobile application. For example, the consent SDK module 120 may generate an API call over a network 130, such as the Internet or a cellular network, to the implementation component 214 that may include information identifying the particular mobile application. In turn, the implementation component 214 may then query the configuration information for the mobile application from the application repository and return the configuration information along with the list of SDKs to the consent SDK module 120, which is received in Operation 420.

In Operation 430, the consent SDK module 120 displays a consent interface to the user. In various aspects, the consent interface solicits consent from the user with respect to the different functionality categories associated with the third-party SDKs used in the development of the mobile application. In some instances, a user's consent may not be needed for a particular functionality category. For example, the SDK may not perform any functionality that involves personal data of the user. Therefore, consent for allowing the functionality associated with the particular third-party SDK to be executed may not be needed from the user.

In other instances, consent may not be needed for a particular functionality category based on attributes, characteristics, conditions, and/or the like of the user and/or the user's computing device. For example, whether consent is required for a particular functionality category may be contingent on a location associated with the user and/or the user's computing device. As a specific example, the location (e.g., jurisdiction) of the user and/or the user's computing device may identify whether or not privacy standards and/or laws are in place that may require consent from the user for a particular functionality category. Here, for example, the consent SDK module 120 may determine the location of the user's computing device based on global positioning system (GPS) data gathered from the device, or the consent SDK module 120 may determine the location of the user based on information gathered by the application from the user such as a home address. If such privacy standards and/or laws are not in place, then the consent SDK module 120 may not need to solicit the user for consent for the particular functionality category. Other circumstances may dictate whether a user may need to be solicited for consent for a particular functionality category. Therefore, in various aspects, the consent SDK module 120 determines the functionality categories associated with the third-party SDKs used for the mobile application for which consent is needed from the user, and generates and displays the consent interface to the user accordingly.

The consent interface can be displayed to the user along with an input element for each functionality category to allow for the user to accept (provide) and/or decline consent for the respective functionality category. For example, the input element displayed on the interface for each functionality category may be a button, a toggle switch, a dropdown menu, a checkbox, and/or the like that the user may use to indicate that he or she accepts or declines consent for the respective functionality category. Once identified, the consent interface may provide the user with another mechanism, such as a button displayed on the interface, to record the user's indication of consent for each of the functionality categories. In turn, the consent SDK module 120 logs the user's consent in Operation 440.

In various aspects, the consent SDK module 120 can log the consent on the user's computing device and/or can communication the user's consent to the SDK consent computing system 100 (or some other system), so that the user's consent can be logged within a repository found in the SDK consent computing system 100. In some aspects, the user's consent logged on the SDK consent computing system 100 (or some other system) can provide a record of the user's consent that is kept separate from the user's computing device and can be used, for example, as proof of receiving the user's consent.

In Operation 450, the consent SDK module 120 actions the consent received from the user for the different functionality categories. In various aspects, the consent SDK module 120 performs this particular operation by either allowing a third-party SDK associated with a particular functionality category to operate based on the user's consent or by blocking the third-party SDK from initializing so that the functionality associated with the SDK is not executed for the mobile application. Therefore, the consent SDK module 120 determines, for each functionality category, whether the user has or has not provided consent for the respective functionality category.

If the user has provided consent for the respective functionality category, then the consent SDK module 120 allows the third-party SDKs associated with the respective functionality category to operate. As a result, the functionality associated with these third-party SDKs executes with respect to the mobile application. For example, this can include functionality that involves the use of personal data of the user.

However, if the user has not provided consent for the respective functionality category, then the consent SDK module 120 blocks the third-party SDKs associated with the respective functionality category from initializing for the mobile application. In some aspects, the consent SDK module 120 blocks the third-party SDKs by generating API calls for the third-party SDKs. For example, the consent SDK module 120 can generates an API call for a particular third-party SDK that sets a consent flag for the third-party SDK that indicates to the SDK to not initialize and execute the functionality associated with the SDK for the mobile application. In additional or alternative aspects, the consent SDK module 120 can generate an API call for a particular third-party SDK that directly prevents the SDK from initializing and, therefore, prevents the functionality associated with the SDK from executing for the mobile application. As a result, any functionality associated with these third-party SDKs is not executed during the user's interaction with the mobile application.

In additional or alternative aspects, the consent SDK module 120 can action a user's consent with respect to the different third-party SDKs without soliciting the user for consent each time the user interacts with the mobile application. For example, the consent SDK module 120 can solicit the user's consent for the different functionality categories during the user's initial interaction with the mobile application and log the user's consent. Therefore, after the initial interaction, the consent SDK module 120 can retrieve the user's previously provided consent automatically and action the consent accordingly without having to solicit the user's consent again for the different functionality categories.

Further, in additional or alternative aspects, the consent SDK module 120 can include program code for implementing the necessary API calls needed to action consent for the various functionality categories. In some aspects, the SDK consent computing system 100 can be used in updating and maintaining the consent SDK that is imported into the mobile applications to include the necessary API calls needed to action consent for known third-party SDKs. As a result, a developer of a mobile application may not be required to write native code for the mobile application to action consent. Instead, the developer can integrate (e.g., import) the consent SDK into the mobile application to have the necessary API calls to action consent for the different functionality categories. Accordingly, such a configuration can lead to reduced overhead, reduced development time, and increased efficiency in developing mobile software applications.

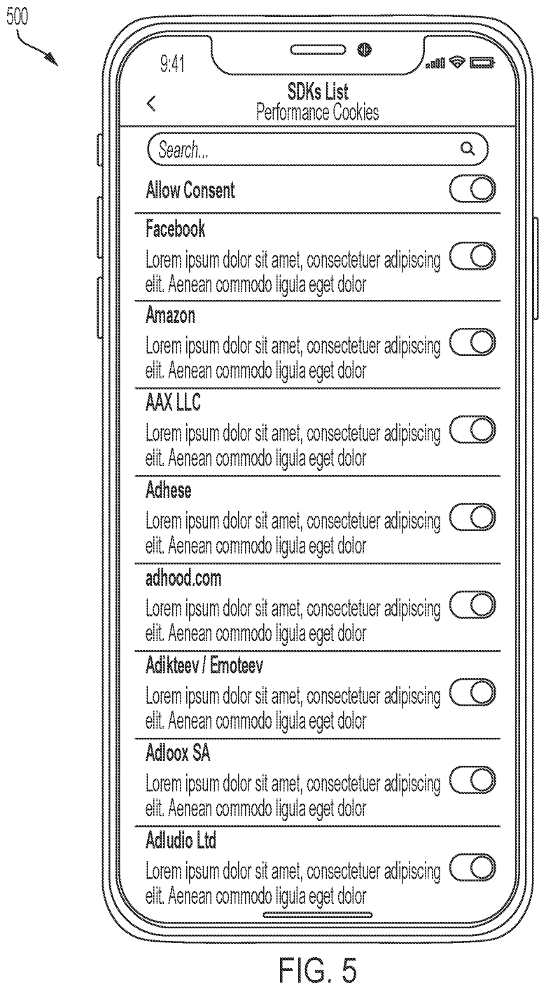

Furthermore, in additional or alternative aspects, the consent SDK module 120 can solicit consent for individual third-party SDKs in addition to, or instead of, functionality categories. For example, the consent interface can display individual third-party SDKs used for the mobile application and provide an input element for each of the third-party SDKs. In some aspects, the consent SDK module 120 can solicit consent for a combination of functionality categories and individual third-party SDKs. For example, the consent SDK module 120 can solicit consent for the functionality category for performance related functionality and solicit consent for the individual SDKs associated with the functionality category for social media related functionality. FIG. 5 provides an example of a consent interface 500 that may be used according to particular aspects to solicit consent for individual third-party SDKs.

### Example Technical Platforms

Aspects of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example aspects, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

According to various aspects, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

According to various aspects, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where various aspects are described to use a computer-readable storage medium, other types of computer-readable storage media may be substituted for or used in addition to the computer-readable storage media described above.

Various aspects of the present disclosure may also be implemented as methods, apparatuses, systems, computing devices, computing entities, and/or the like. As such, various aspects of the present disclosure may take the form of a data structure, apparatuses, system, computing device, computing entity, and/or the like executing instructions stored on a computer-readable storage medium to perform certain steps or operations. Thus, various aspects of the present disclosure also may take the form of entirely hardware, an entirely computer program product, and/or a combination of computer program products and hardware performing certain steps or operations.

Various aspects of the present disclosure are described below with reference to block diagrams and flowchart illustrations. Thus, each block of the block diagrams and flowchart illustrations may be implemented in the form of a computer program product, an entirely hardware aspect, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. According to some aspects, retrieval, loading, and/or execution may be performed in parallel such that multiple instructions are retrieved, loaded, and/or executed together. Thus, such aspects can produce specially configured machines performing the steps or operations specified in the block diagrams and flowchart illustrations. Accordingly, the block diagrams and flowchart illustrations support various combinations of aspects for performing the specified instructions, operations, or steps.

### Example System Architecture

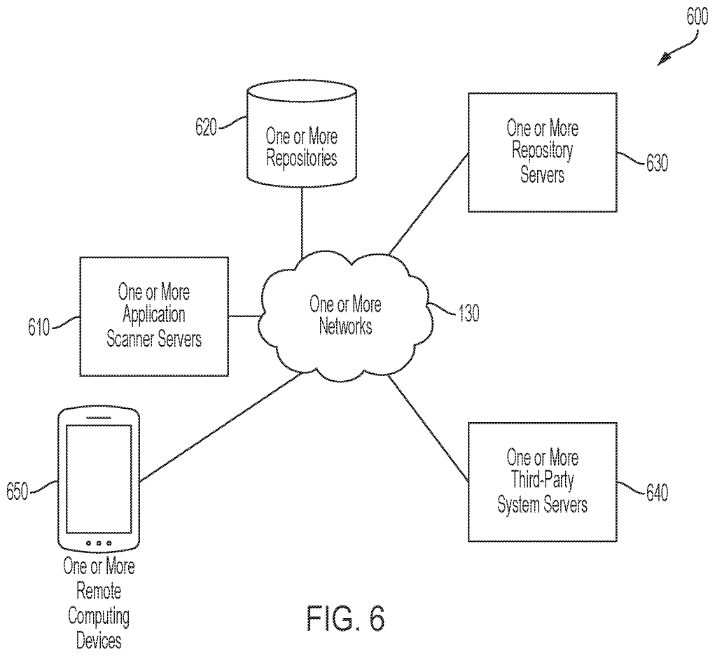

FIG. 6 is a block diagram of a system architecture 600 that can be used in implementing various aspects of the disclosure as detailed herein. In various aspects, entities of the system architecture 600 are configured to analyze software applications, such as software mobile applications that are executed on computing devices, to identify and categorize third-party SDKs used in implementing the software applications. For example, the entities can analyze software applications that have been provided by one or more third-party application developers, one or more application provider servers, or other systems, and/or that have been installed on one or more remote devices. In addition, entities of the system architecture 600 are configured to facilitate the soliciting of consent from users of the software applications and action such consent with respect to the third-party SDKs identified for the different software applications during the analysis.

As may be understood from FIG. 6, the system architecture 600 can include one or more application scanner servers 610, one or more computer networks 130, one or more repositories 620 (such as, for example, the SDK repository and application repository previously described herein), and one or more repository servers 630. In various aspects, the application scanner server(s) 610, repositor(ies) 620, and/or repository server(s) 630 may be components found within the SDK consent computing system 100 as previously described. Although the application scanner server(s) 610, repositor(ies) 620, and repository server(s) 630 are shown as separate entities, it should be understood that according to other aspects, these entities 610, 620, 630 may comprise a single server and/or repository, a plurality of servers and/or repositories, one or more cloud-based servers and/or repositories, or any other suitable configuration.

In various aspects, the application scanner server(s) 610 acquire a software application that is uploaded from a remote third-party system server 640 and execute an application scanner module 110 as described herein to analyze the software application and generate information on the third-party SDKs used in implementing the software application. In some aspects, the application scanner server(s) 610 can reference an SDK repository 620 in conducting the analysis.

In various aspects, the repository server(s) 630 store information generated by the application scanner server(s) 610 in an application repository 620. For example, the repository server(s) 630 can receive information generated by the application scanner server(s) 610 based on analyzing software applications that includes configuration information on the software applications, as well as information on third-party SDKs used in providing functionality in the software applications.

In some aspects, the repository server(s) 630, serving as the implementation component 214, can then query and provide the information stored in the application repository 620 in response to requests received over the network(s) 130 from software applications (e.g., from the consent SDK module 120 as described herein) executing on remote computing devices 650. For example, a remote computing device 650 can include a smartphone, laptop computer, tablet computer, and/or the like. Here, the remote computing device 650 can be associated with a user who is interacting with a software application that was previously analyzed as detailed herein and is residing on the device 650. Accordingly, the repository server(s) 630 can provide the remote computing device 650 with the configuration information on the software application that can include a list of third-party SDKs that have been used to implement functionality for the software application. The application scanner server(s) 610 and/or repository server(s) 630 may interface with the third-party system server(s) 640 and/or the remote computing devices 650 via one or more suitable application programming interfaces (APIs), direct connections, and/or the like.

### Example Computing Hardware

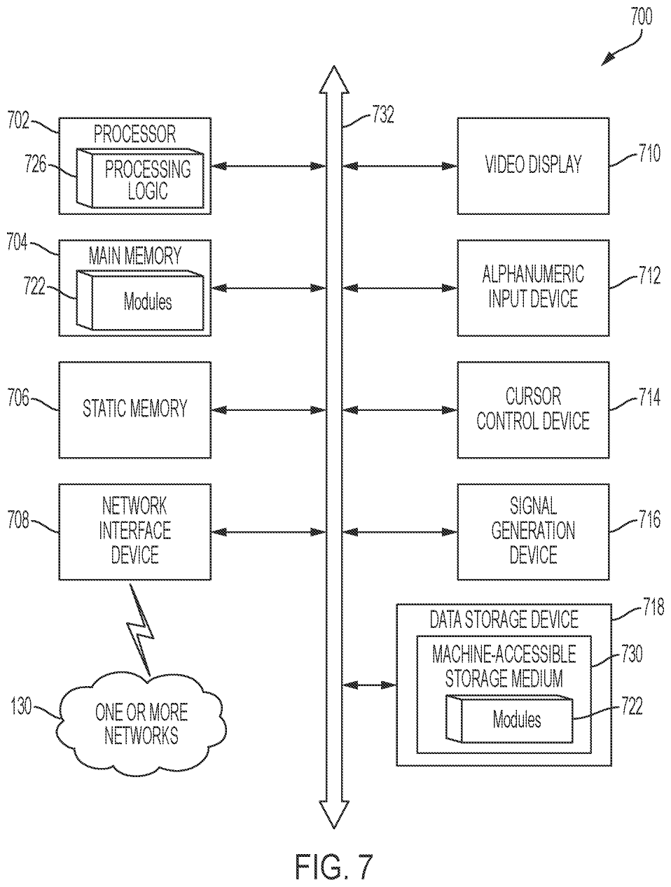

FIG. 7 illustrates a diagrammatic representation of a computing hardware device 700 that may be used in accordance with various aspects of the disclosure. For example, the hardware device 700 may be computing hardware such as a server 610, 630 and/or a remote computing device 650 as described in FIG. 6. According to particular aspects, the hardware device 700 may be connected (e.g., networked) to one or more other computing entities, storage devices, and/or the like via one or more networks such as, for example, a LAN, an intranet, an extranet, and/or the Internet. As noted above, the hardware device 700 may operate in the capacity of a server and/or a client device in a client-server network environment, or as a peer computing device in a peer-to-peer (or distributed) network environment. According to various aspects, the hardware device 700 may be a personal computer (PC), a tablet PC, a set-top box (STB), a Personal Digital Assistant (PDA), a mobile device (smartphone), a web appliance, a server, a network router, a switch or bridge, or any other device capable of executing a set of instructions (sequential or otherwise) that specify actions to be taken by that device. Further, while only a single hardware device 700 is illustrated, the term “hardware device,” “computing hardware,” and/or the like shall also be taken to include any collection of computing entities that individually or jointly execute a set (or multiple sets) of instructions to perform any one or more of the methodologies discussed herein.

A hardware device 700 includes a processor 702, a main memory 704 (e.g., read-only memory (ROM), flash memory, dynamic random-access memory (DRAM) such as synchronous DRAM (SDRAM), Rambus DRAM (RDRAM), and/or the like), a static memory 706 (e.g., flash memory, static random-access memory (SRAM), and/or the like), and a data storage device 718, that communicate with each other via a bus 732.

The processor 702 may represent one or more general-purpose processing devices such as a microprocessor, a central processing unit, and/or the like. According to some aspects, the processor 702 may be a complex instruction set computing (CISC) microprocessor, reduced instruction set computing (RISC) microprocessor, very long instruction word (VLIW) microprocessor, processor implementing other instruction sets, processors implementing a combination of instruction sets, and/or the like. According to some aspects, the processor 702 may be one or more special-purpose processing devices such as an application specific integrated circuit (ASIC), a field programmable gate array (FPGA), a digital signal processor (DSP), network processor, and/or the like. The processor 702 can execute processing logic 726 for performing various operations and/or steps described herein.

The hardware device 700 may further include a network interface device 708, as well as a video display unit 710 (e.g., a liquid crystal display (LCD), a cathode ray tube (CRT), and/or the like), an alphanumeric input device 712 (e.g., a keyboard, a trackpad), a cursor control device 714 (e.g., a mouse), and/or a signal generation device 716 (e.g., a speaker). The hardware device 700 may further include a data storage device 718. The data storage device 718 may include a non-transitory computer-readable storage medium 730 (also known as a non-transitory computer-readable storage medium or a non-transitory computer-readable medium) on which is stored one or more modules 722 (e.g., sets of software instructions) embodying any one or more of the methodologies or functions described herein. For instance, according to particular aspects, the modules include an application scanner module 110 or a consent SDK module 120 as described herein. The one or more modules 722 also may reside, completely or at least partially, within main memory 704 and/or within the processor 702 during execution thereof by the hardware device 700—main memory 704 and processor 702 also constituting computer-accessible storage media. The one or more modules 722 may further be transmitted or received over a network 130 via the network interface device 708.

While the computer-readable storage medium 730 is shown to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, and/or carrying a set of instructions for execution by the hardware device 700 and that causes the hardware device 700 to perform any one or more of the methodologies of the present disclosure. The term “computer-readable storage medium” should accordingly be understood to include, but not be limited to, solid-state memories, optical and magnetic media, and/or the like.

### System Operation

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, steps, structural devices, acts, or modules. These states, operations, steps, structural devices, acts, and modules may be implemented in software, in firmware, in special purpose digital logic, and any combination thereof. Greater or fewer operations may be performed than shown in the figures and described herein. These operations also may be performed in a different order than those described herein.

### Conclusion

While this specification contains many specific aspect details, these should not be construed as limitations on the scope of any invention or of what may be claimed, but rather as descriptions of features that may be specific to particular aspects of particular inventions. Certain features that are described in this specification in the context of separate aspects may also be implemented in combination in a single aspect. Conversely, various features that are described in the context of a single aspect also may be implemented in multiple aspects separately or in any suitable sub-combination. Moreover, although features may be described above as acting in certain combinations and even initially claimed as such, one or more features from a claimed combination may in some cases be excised from the combination, and the claimed combination may be a sub-combination or variation of a sub-combination.

Similarly, while operations are described in a particular order, this should not be understood as requiring that such operations be performed in the particular order described or in sequential order, or that all described operations be performed, to achieve desirable results. In certain circumstances, multitasking and parallel processing may be advantageous. Moreover, the separation of various components in the various aspects described above should not be understood as requiring such separation in all aspects, and the described program components (e.g., modules) and systems may generally be integrated together in a single software product or packaged into multiple software products.

Many modifications and other aspects of the disclosure will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for the purposes of limitation.

What is claimed is:

1. A method comprising:
generating, by computing hardware, a first application interface (API) call over a network to a remote computing system to request a list of software development kits (SDKs) providing functionality for a mobile application;
receiving, by the computing hardware and from the remote computing system, the list of SDKs over the network, wherein the list of SDKs comprises a first SDK associated with a first functionality category and a second SDK associated with a second functionality category;
causing, by the computing hardware, display of a consent interface within the mobile application, wherein the consent interface comprises:
a first input element configured for receiving consent for the first functionality category, and
a second input element configured for receiving consent for the second functionality category;
receiving, by the computing hardware and via the first input element, first input indicating the consent for the first functionality category;
receiving, by the computing hardware and via the second input element, second input indicating a lack of the consent for the second functionality category;
responsive to the first input, allowing, by the computing hardware, first functionality provided by the first SDK to operate within the mobile application; and
responsive to the second input, generating, by the computing hardware, a second API call to block the second SDK from initiating second functionality operating for the mobile application.

2. The method of claim 1 further comprising logging the first input and the second input on at least one of the remote computing system or the computing hardware.

3. The method of claim 2, wherein after logging the first input and the second input, the method further comprises:
detecting, by the computing hardware, a user interacting with the mobile application; and
responsive to detecting the user interacting with the mobile application:
retrieving, by the computing hardware, the first input and the second input;
responsive to the first input, allowing, by the computing hardware, the first functionality provided by the first SDK to operate within the mobile application; and
responsive to the second input, generating, by the computing hardware, a third API call to block the second SDK from initializing the second functionality operating for the mobile application.

4. The method of claim 1, wherein the list of SDKs comprises a third SDK associated with a third functionality category, and the method further comprises:
determining, by the computing hardware, that consent for the third functionality category is not required; and
responsive to determining the consent for the third functionality category is not required, causing, by the computing hardware, display of the consent interface within the mobile application without a third input element configured for receiving the consent for the third functionality category.

5. The method of claim 4, wherein determining that the consent for the third functionality category is not required comprises:
determining a location of at least one of the computing hardware or a user of the mobile application; and
determining that the consent for the third functionality category is not required based on the location.

6. The method of claim 1, wherein the second API call to block the second SDK from initiating the second functionality performs at least one of setting a consent flag that indicates to the second SDK not to initialize or directing preventing the second SDK from initializing.

7. The method of claim 1, wherein the list of SDKs comprises a third SDK, and the method further comprises:
causing, by the computing hardware, display of the consent interface within the mobile application, wherein the consent interface comprises a third input element configured for receiving consent for the third SDK;
receiving, by the computing hardware and via the third input element, third input indicating a lack of the consent for the third SDK; and
responsive to the third input, generating, by the computing hardware, a third API call to block the third SDK from initiating third functionality operating for the mobile application.

8. A system comprising:
a non-transitory computer-readable medium storing instructions; and
a processing device communicatively coupled to the non-transitory computer-readable medium,
wherein, the processing device is configured to execute the instructions and thereby perform operations comprising:
decompiling a software application to produce application code for the software application;
scanning the application code to identify at least one of non-native functionality, a non-native attribute, or a non-native characteristic of the application code;
accessing a repository containing data on known third-party software development kits (SDKs);
identifying, based on the data in the repository, at least one of known functionality, a known attribute, or a known characteristic that matches at least one of the non-native functionality, the non-native attribute, or the non-native characteristic;
determining, based on at least one of the known functionality, the known attribute, or the known characteristic, a source SDK for at least one of the non-native functionality, the non-native attribute, or the non-native characteristic;
assigning a functionality category to at least one of the non-native functionality, the non-native attribute, or the non-native characteristic; and
storing, in a second repository, an indication of the source SDK and the functionality category for the software application.

9. The system of claim 8, wherein the software application comprises a mobile application for a mobile device.

10. The system of claim 8, wherein scanning the application code identifies at least one of second non-native functionality, a second non-native attribute, or a second non-native characteristic of the application code, and the operations further comprise:
executing the software application;
providing the software application, while executing, dummy data to generate output that is associated with at least one of the second non-native functionality, the second non-native attribute, or the second non-native characteristic;
analyzing the output;
identifying, based on analyzing the output, a second source SDK for at least one of the second non-native functionality, the second non-native attribute, or the second non-native characteristic;
assigning a second functionality category to at least one of the second non-native functionality, the second non-native attribute, or the second non-native characteristic; and
storing, in the second repository, a second indication of the second source SDK and the second functionality category for the software application.

11. The system of claim 10, wherein identifying the second source SDK for at least one of the second non-native functionality, the second non-native attribute, or the second non-native characteristic via executing the software application is carried out based on a failure to identify at least one of second known functionality, a second known attribute, or a second known characteristic that matches at least one of the second non-native functionality, the second non-native attribute, or the second non-native characteristic from the data in the repository.

12. The system of claim 10, wherein analyzing the output comprises processing the output using a machine-learning model to generate a prediction for each third-party SDK of a plurality of third-party SDKs, wherein the prediction provides a likelihood of the third-party SDK being a source of at least one of the second non-native functionality, the second non-native attribute, or the second non-native characteristic.

13. The system of claim 12, wherein the second source SDK is one of the plurality of third-party SDKs and identifying the second source SDK for at least one of the second non-native functionality, the second non-native attribute, or the second non-native characteristic is based on the prediction generated for the second source SDK at least one of having a highest value of the predictions or satisfying a threshold.

14. The system of claim 8, wherein the operations further comprise generating, based on the indication of the source SDK and the functionality category for the software application, a consent SDK that is incorporated into the software application and is configured to:
cause display of a consent interface within the software application, wherein the consent interface comprises an input element configured for receiving consent for the functionality category,
receive, via the input element, an input indicating a lack of the consent for the functionality category, and
responsive to the input, generating an application programming interface call to block the source SDK from initiating functionality operating for the software application.

15. A non-transitory computer-readable medium storing computer-executable instructions that, when executed by computing hardware, configure the computing hardware to perform operations comprising:
generating a first application interface (API) call over a network to a remote computing system to request a list of software development kits (SDKs) providing functionality for a software application;
receiving, from the remote computing system, the list of SDKs over the network, wherein the list of SDKs comprises a first SDK associated with a first functionality category;
causing display of a consent interface within the software application, wherein the consent interface comprises an input element configured for receiving consent for the first functionality category;
receiving, via the input element, input indicating a lack of the consent for the first functionality category; and
responsive to the input, generating a second API call to block the first SDK from initiating first functionality operating for the software application.

16. The non-transitory computer-readable medium of claim 15, wherein the operations further comprise logging the input on the remote computing system.

17. The non-transitory computer-readable medium of claim 16, wherein after logging the input, the operations further comprises:
detecting a user interacting with the software application;
responsive to detecting the user interacting with the software application:
retrieving the input; and
responsive to the input, generating a third API call to block the first SDK from initializing the first functionality operating for the software application.

18. The non-transitory computer-readable medium of claim 15, wherein the list of SDKs comprises a second SDK associated with a second functionality category, and the operations further comprise:
determining that consent for the second functionality category is not required; and
responsive to determining the consent for the second functionality category is not required, causing display of the consent interface within the software application without a second input element configured for receiving the consent for the second functionality category.

19. The non-transitory computer-readable medium of claim 15, wherein the second API call to block the first SDK from initiating the first functionality performs at least one of setting a consent flag that indicates to the first SDK not to initialize or directing preventing the first SDK from initializing.

20. The non-transitory computer-readable medium of claim 15, wherein the list of SDKs comprises a second SDK, and the operations further comprise:
causing display of the consent interface within the software application, wherein the consent interface comprises a second input element configured for receiving consent for the second SDK;
receiving, via the second input element, second input indicating a lack of the consent for the second SDK; and
responsive to the second input, generating a third API call to block the second SDK from initiating second functionality operating for the software application.
